(19) United States
(12) Patent Application Publication
(10) Pub. No.: US 2003/0023476 A1
(43) Pub. Date: Jan. 30, 2003

(54) System and method for recording and using incident report data

(75) Inventor: Purvis M. Gainey, Sterling, VA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: IncidentReports, Inc.

(21) Appl. No.: 10/185,720

(22) Filed: Jul. 1, 2002

Related U.S. Application Data
(60) Provisional application No. 60/301,620, filed on Jun. 29, 2001.

(51) Int. Cl. G06F 17/60

(52) U.S. Cl. 705/10

(57) ABSTRACT

The present invention provides a system and method for creating, maintaining, and analyzing incident reports as part of an incident report database from anywhere in the world. Embodiments of the present invention include an incident report database accessible through a universal client, i.e. web-browser functionality, which provides login capabilities, report creation and analysis, and administration of reports and user functionality. PDA report creation, uploading and template downloading capabilities are also provided. Users may be categorized into different permission levels providing varying degrees of accessibility to the database. Reporting options, also depending on a user's permission level, include: creating a report, searching for a report, listing all reports, creating a text report, and creating a graphical report.

### RELATED APPLICATIONS

This application claims priority from U.S. Provisional Application Serial No. 60/301,620, filed Jun. 29, 2001, the disclosure of which is hereby incorporated by reference in its entirety.

### FIELD OF THE INVENTION

Disclosed is a system and method for recording, maintaining, managing, reporting and using incident report data. This system and method allows a business or organization to create, update, and analyze incident reports as part of an incident report database from virtually anywhere in the world via the Internet, as well as through the use of Personal Digital Assistants (PDAs).

### BACKGROUND OF THE INVENTION

For many businesses, tracking various incidents, such as theft, vandalism, personal injury, etc. is an important part of their asset & risk management as well as cost avoidance responsibilities. Typical incident reporting systems generally provide nothing more than a handwritten report form that is ultimately filed in a file cabinet. More sophisticated systems allow for the data to be entered from a handwritten form into electronic databases. For large companies or businesses that track incidents throughout a large geographical area a single data entry point creates a bottleneck and additional difficulties within a data management system.

### SUMMARY OF THE INVENTION

The present invention provides a system and method for creating, maintaining, and analyzing incident reports as part of an incident report database from anywhere in the world. Embodiments of the present invention include an incident report database accessible through a universal client, i.e., web-browser functionality, which provides login capabilities, report creation and analysis, and administration of reports and user functionality. PDA report creation, uploading and template downloading capabilities are also provided. According to a preferred embodiment, client data is stored in MS Access 2000 databases, with optional upgrades to an enterprise level database, SQL Server 2000 or Oracle 9i. The web-application provides login security, reporting options, and administrative options for several permission levels. PDA access provides a form-based application for downloading form templates, and creating reports and uploading the completed reports through either a wired or wireless “sync” internet/intranet connection to an organization's database.

Login functionality provides a mechanism for users to gain access to their companies' report database. All initial logins are created and managed by each organization's assigned systems administrator. Once a user has created a profile, she is able to access the various features of the application, i.e. database lookup tables and reporting options.

In a preferred embodiment, a system administrator is provided with multiple levels of accessibility to be assigned to various users in an organization. For instance, an organization may have four permission levels providing varying degrees of accessibility. In Level 1, a basic permission level, a user may create and modify an incident report. In level 2, the administrative permission level, a user may create a report, search and update any existing incident report that has been filed and saved in final form, view all reports that have been filed within a company's database, including status reports, and create textual and graphical reports. In Level 3, the system administrator permission level, the user may function as a system administrator and have full control over the data in the company's database. As the system administrator, the user may create a new incident report, search for and update any existing incident report, create textual and graphical reports, and manage the data-driven select lists, user accounts and options for their company's user interface and database. In Level 4, the user has investigator permission privileges and may search for and update any specific section on an incident report saved in final form. As an investigator, the user having level 4 permissions may view all report sections and data. The investigator also has an additional section of the report where he may enter any data discovered during the investigation of the incident.

Reporting options, depending on a user's permission level, according to the present invention include: creating a report, searching for a report, listing all reports, creating a text report, and creating a graphical report. When creating a report the reporting application provides check boxes and free form text windows to allow a user to describe and report any event according to the company's requirements.

Various searches may be performed on the reports within the database and analysis reports may also be generated, including textual and graphical reports. For instance, in the four level permission system described above, users having permission levels 2, 3 or 4 may perform searches. Specifically, searches according to the present invention generate a hyperlink list to those reports meeting the search criteria.

Several types of textual reports and graphical reports may be provided by the present invention. The standard textual reports provided by the present invention include: by incident type, incidents, theft in dollars, incident updates, and incidents by location. The standard graphical reports include: reports by type, reports by location, and thefts in dollars, presented in bar charts, and reports by incidents, presented in a pie chart. Generally only users with proper permission level accessibility may create or access the reports. For example, the above-described system having four permission levels allows users of permission levels 2 and 3 to access automatically created textual reports and graphical reports, while also allowing a system administrator (i.e., a user having level 3 permissions) to create custom reports.

Users having sufficient privileges, such as a system administrator of level 3, may also manage access to a company's database, as well as customize the reporting forms associated with the reporting application. Administrative options according to the present invention include: managing users, managing business units, managing incident types, managing incident status, managing locations, managing pager services, managing permissions, managing permission categories, managing person types, managing stolen object types, managing stolen item categories, and managing system data.

Incident reporting according to the present invention may also include the ability to use a handheld computing device such as a personal data assistant (PDA) for remote reporting and/or even wireless reporting when full Internet accessibility is not preferred or available. The present invention provides a form-based application that allows a user to download report templates, enter report data, and upload completed reports through a wireless connection or through a hardware “sync” cradle or other known connection technologies. Entry screens similar to those provided in the web-based application are presented on the PDA screen. The user simply makes the report selections and is also able to enter free form text information. When a report is completed it may be saved in the PDA and additional reports may be written.

During a first login to the web-based application, information to create a user profile is requested. Any further logins may by-pass the profile set-up and take the user directly to the application interface.

A user entering an incident report is able to navigate through various reporting screens that allow selection of default or customized categories as well as the entry of free-form text data. Images may also be attached to an incident report. Administrative activities are also provided to users with the proper permissions. Additional menus are provided to a system administrator level login, which allows the system administrator to manage access permissions and customize the various report menus.

After creation of the report, an end user may optionally modify the report for easier use and presentation. For example, the end user may reformat the report or otherwise make the report more “printer friendly” for easier printing. The end user may also electronically transmit the report to another person via e-mail or email attachment. Alternatively, the end user may convert the report to Rich Text Format (RTF) for use on any word processor that support the RTF format, such as Word® by Microsoft Corp. or WordPerfect® of Corel Corp. Similarly, the end user may convert the report to Portable Document Format (PDF) to allow the report to be read using Acrobat® by Adobe Systems Inc. It should be appreciated that the end user may otherwise modify or reformat the report as needed and known in the field of computer data presentation.

In a preferred implementation, the present invention is an incident reporting software solution delivered as an Internet Business Service or as an intranet application available from a desktop, mobile, or handheld computing device in direct support of users, including security and safety professionals. Users may create new incident reports or access existing incident reports data using state-of-the-art data encryption technology, such as SSL (Secure Sockets Layer) 128-bit encryption methodology. In this way, the present invention provides a reporting engine to allow users to manage asset/risk management and loss prevention efforts via a network or Internet connection and a standard web browser. Overall, the present invention may combine the features of a hosting platform, the database solution, daily database backups, 128-bit or greater encryption, superior text and graphical reporting results with both e-mail and paging capabilities.

Overall, the present invention provides numerous advantages including minimizing the need for information technology personnel support; reducing the need for ongoing costly software and/or hardware investments; securing report data using state-of-the-art encryption technology; minimizing the paper process to increase productivity and efficiencies; providing compatibility with a user's existing report data; providing the incident reporting solution from reports your handheld computing device; allowing users to remotely access incident from anywhere securely, i.e. office, home or while traveling.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 illustrates a system for recording and using incident report data in accordance with an embodiment of the present invention; and

FIGS. 2-4 illustrates the steps in a related method for recording and using incident report data in accordance with an embodiment of the present invention.

### DETAILED DESCRIPTION OF THE PREFERRED EMBODIMENTS

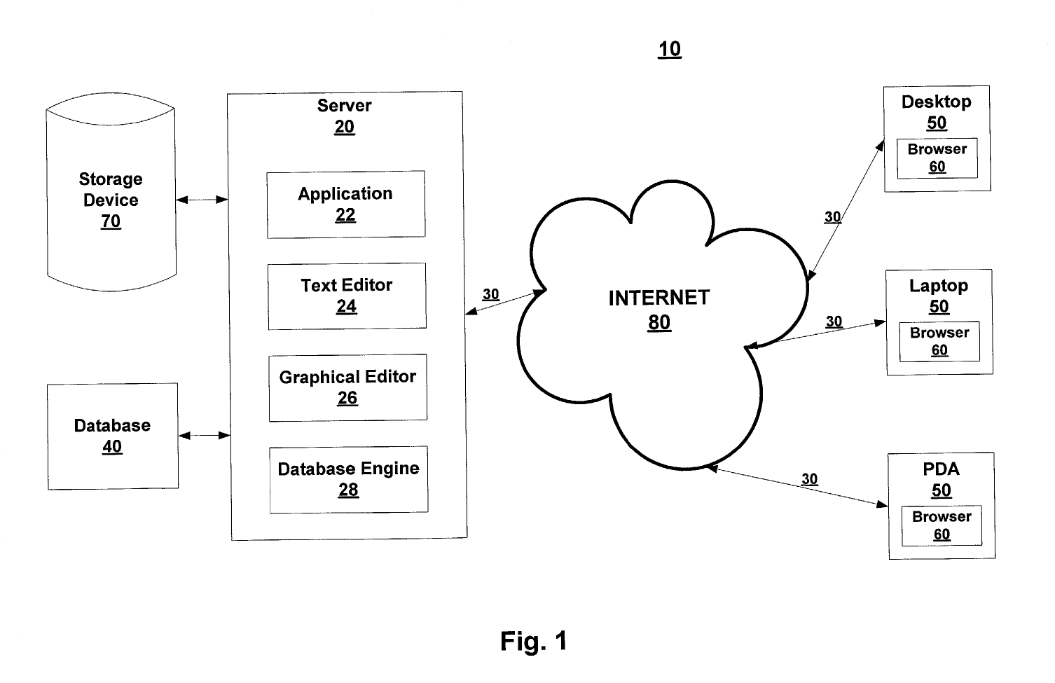

As generally illustrated in FIGS. 1 and 2-4, the present invention provides a system 10 and a method 90, respectively, for recording and using incident report data. Using the system 10 and the method 90, a user may create, maintain, and analyze incident reports as part of an incident report database from anywhere in the world. Embodiments of the present invention include an incident report database accessible through a universal client, i.e. web-browser functionality, that provides login capabilities, report creation and analysis, and administration of reports and user functionality. PDA report creation, uploading and template downloading capabilities are also provided. Users may be categorized into different permission levels providing varying degrees of accessibility to the database. Reporting options, which depend on a user's permission level, include: creating a report, searching for a report, listing all reports, creating a text report, and creating a graphical report.

Incident Report System

The incident report system 10 of the present invention is generally depicted in FIG. 1. The system 10 generally includes a server 20; the incident report application 22; a text editor 24; a graphical editor 26; a database engine 28; an Internet connection 30; an incident report database 40; one or more computing devices 50 (desktop, laptop and PDA) each having a web browser 60 to access the server 20; a storage device 70 containing other files; and the Internet 80.

In the implementation of FIG. 1, the incident report system 10 is implemented over a network. By definition, a network is a group of computers and associated devices that are connected by communications facilities or links. Network communications can be of a permanent nature, such as via cables, or can be of a temporary nature, such as connections made through telephone or radio links. Networks may vary in size, from a local area network (LAN) consisting of a few computers or workstations and related devices; to a wide area network (WAN) that interconnects computers and LANs that are geographically dispersed; onto a remote access service (RAS) that interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that may use the Transmission Control Protocol/Internet Protocol (TCP/IP) to communicate with one another.

A section of the Internet typically may contain a plurality of local area networks (LANs) and a wide area network (WAN) interconnected by routers. The routers are generally special purpose computers used to interface one LAN or WAN to another. Communication links within the LANs may be twisted wire pair, or coaxial cable, while communication links between networks may utilize 56 Kbps analog telephone lines, or 1 Mbps digital T-1 lines and/or 45 Mbps T-3 lines. Further, computers and other related electronic devices can be remotely connected to either the LANs or the WAN via a modem and temporary telephone link. It will be appreciated that the Internet comprises a vast number of such interconnected networks, computers, and routers. Each of these connections is an example of an internet connection 30.

The Internet 80 has recently seen explosive growth by virtue of its ability to link computers located throughout the world. As the Internet has grown, so has the World Wide Web (WWW). The WWW is a vast collection of interconnected or “hypertext” documents written in HyperText Markup Language (HTML) that are electronically stored at “Websites” throughout the Internet. A Website is a server connected to the Internet that has mass storage facilities for storing hypertext documents and that runs administrative software for handling requests for those stored hypertext documents. A hypertext document normally includes a number of hyperlinks, i.e., highlighted portions of text which link the document to another hypertext document possibly stored at a Website elsewhere on the Internet. Each hyperlink is associated with a Uniform Resource Locator (URL) that provides the exact location of the linked document on a server connected to the Internet and describes the document. Thus, whenever a hypertext document is retrieved from any Web server, the document is considered to be retrieved from the WWW.

A user is allowed to retrieve hypertext documents from the WWW, i.e., a user is allowed to “surf the Web,” via a Web browser 60. The Web browser 60, such as Netscape's Navigator or Microsoft's Internet Explorer, is a software program implemented by a Web client, i.e., the consumer's computer 50, to provide a graphical user interface to the WWW. Upon request from the consumer via the Web browser, the Web client 50 accesses and retrieves the desired hypertext document from the appropriate Web server using the URL for the document and a protocol known as HyperText Transfer Protocol (HTTP). HTTP is a higher-level protocol then TCP/IP and is designed specifically for the requirements of the WWW. It may be used on top of TCP/IP to transfer hypertext documents between servers and clients.

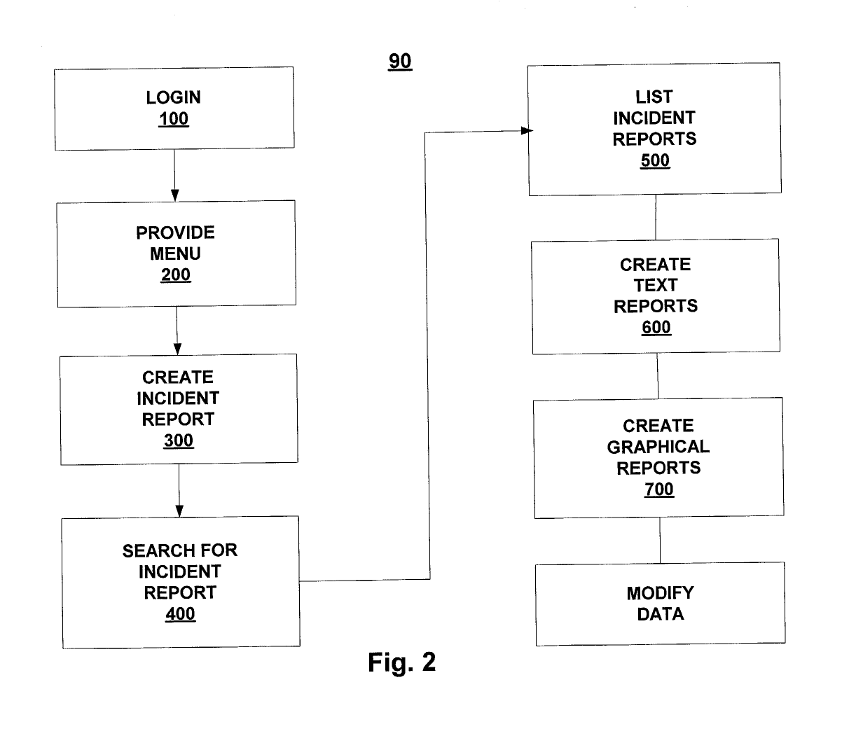

An incident report application server 20 contains an incident report application 22 implementing the implement report method 90 of FIG. 2. The incident report application server 20 may further include a text editor 24, a graphical editor 26, and a database engine 28, as needed for the operation of the incident report application 22. During the operation of the incident report application 22, the database engines 28 interface with the database 40 to obtain existing user, organization, and incident report data and to store new user, organization and incident report data.

In an embodiment of the present invention, the incident report application server 20 may be insulated from the Internet 80 by a firewall server which tracks and controls the flow of all data passing through it using the TCP/IP protocol. That is, the firewall protects the incident report application server 20 from malicious in-bound data traffic.

Although displayed as a single device, the incident report application server 20 may be, in fact, a bus network interconnecting various computers and servers. In this implementation, the incident report application server 20 is formed of various coupling media such as glass or plastic fiberoptic cables, coaxial cables, twisted wire pair cables, ribbon cables, etc. In addition, one of ordinary skill in the art will appreciate that the coupling medium may also include a radio frequency coupling media or other intangible coupling media.

As described above, any computer system, or number of computer systems, including but not limited to workstations, personal computers, laptop computers, servers, remote computers, PDAs, etc., that is equipped with the necessary interface hardware may be connected temporarily or permanently to the Internet 80 via the Internet interfaces 30 and thus, the incident report application server 20. PDAs may also connect through various internet interfaces 30. For instance, PDAs may connect through a wireless interface to the Internet through wireless LAN (“WLAN”) technologies using a variety of protocols, including, but not limited to: x802. 11a, x802.11b, WCTP, Bluetooth, and Ricochet. It is well known that these protocols provide users with the ability to easily interact with a wide range of network applications that include voice and data applications. The equipment used to access the network may include PDAs, voice headsets, and cellular phones. The equipment that the users will be accessing with these devices could, of course, include other similar devices (point-to-point exchanges), LAN access units, or other access units designed to provide connectivity to an assortment of facilities. Alternatively, a PDA may be directly connected to a computing device through a cradle or other known connection interfaces that allows the PDA to transfer data to the other computing device. In turn, the computing device may connect to the Internet 80 and transfer data transferred from the PDA to the incident report server 20.

In another embodiment, the incident report server 20 further connects with a storage device 70 containing other data. For instance, as described below in step 350, a user may access and integrate text and graphical images into an incident report created by using the present invention. For instance, a user may add an image file containing a picture of the incident.

In one implementation, the client data is stored in a database, such as Microsoft's Access 2000®. The incident report application 22 is then fully data-driven using pass-through queries directly to the client's database 40. Performance of the client's database 40 may be monitored regularly, and the client may be notified when the database exceeds a predetermined storage capacity.

Likewise, the client's database may be an enterprise level database, such as SQL Server 7.0. The procedures in the incident report application 22 may use be stored. Stored procedures are compiled in the database and give a noticeable performance benefit vis-a-vis using pass-thru queries that pass the query string along the URL to the database server. Preferably, database activities from the incident reports application, such as inserting data, updating data, deleting data and selecting data for report display, are performed through stored procedures.

The incident report system 100 generally employs a tiered process view including:

User Interface Tier consisting of rendered HTML pages that run in the user's web browser 50. Functionality in this tier should be limited to simple field validation. This tier includes look and feel options, content delivery to the user, primary site navigation, and simple field validation.

Presentation Tier: Consisting of static HTML pages that are sent to the user's browser to generate the User Interface Tier. The Presentation Tier has several distinct responsibilities including security through user validation done at the application level; state management through the application framework defined for each client application since, when a user logs in to the application, client variables are set on the user's machine; site navigation by controlling navigation into the database when the user follows a link. The user's Access Profile and assigned Account Permission Level (both described below) further affect site navigation.

Database Tier: Consisting of multiple databases that store user accounts, security information, Incident Report data, etc. This tier will enforce data security to the level that only application systems can access the data. The database servers are not physically connected to the network, thus making it difficult for an outsider to gain unauthorized access to the database server. The connection to the database is maintained through an automated Administrator. The data source defined in the Administrator will be configured to use the database account created to access the database. Databases may be encrypted with the encryption keys stored separately from the database files. Databases are assigned a unique password that is not shared. The database tier will enforce persistent data constraints (e.g., existence, referential integrity, and permissible values). Similarly, the database tier will provide persistent storage for all information that will persist across sessions. When data must be replicated across multiple servers, the data tier will ensure replication of this information.

The deployment view of the architecture describes the computer hardware and operating systems and the network onto which the application will be deployed. The Client Tier generally includes the User Interface Tier containing the browser 60. The browser 60 may require the use of the an ActiveX control plug-in. Subsequently, the Internet Tier contains all networking between the client and the incident reports application including Internet connectivity at both the client and service provider ends of the Internet. Customers may access the site from their respective connections to the Internet using Secure Hypertext Transfer Protocol (HTTP). A Web Server Tier contains Web server(s) that respond to the client HTTP requests. Requests will be passed through the application server tier for processing. Both static HTML pages and dynamic content (e.g., data-driven templates) will be produced and transported from this tier. An Application Server Tier contains the Application Server that responds to requests sent from the web server tier. The Database Tier contains database server(s) providing persistent data storage. The Application Server is the only means of communication to the database tier through the incident reports application. Users do not generally have direct access to the Database Tier.

As will be readily appreciated by one of ordinary skill in the art of commercial web page design and hosting, the incident report system 10 according to embodiments of the present invention is comprised of suitable servers (including web servers, database servers, and other known computing devices), storage devices (including databases as herein described and other suitable storage means), memory devices and support hardware operating software instructions as is known in the art to achieve the functions as herein described. It will, however, be readily appreciated by one of ordinary skill in the art that the functions of the related methods for the certification network herein described can be alternatively performed by a single computing device or by many computing devices in electronic communication with each other and the Internet.

Incident Report Method

Referring now to FIGS. 2-4, the present invention further includes an incident report method 90 for using the incident report system 10. The method generally entails the steps of logging in a use (Step 100); providing a user-specific navigation system (step 200); creating an incident report (step 300); searching the incident reports (steps 400-500); creating text and graphic reports (step 600-700); and managing the data used in steps 100-700 (steps 800-2500).

Login

To access the Incident Report system of the present invention, a user first logins, step 100. For any user in an organization, a user profile containing account information is created by the organization's System Administrator. The System Administrator may initialize the user's login name and initial password for the account. Typically, the System Administrator enters the user's first and last name, e-mail address, the user name, initial password, and specifies the user's level of access. The user's level of access determines the possible actions that the user may undertake in the connection with an incident report. Once the user receives their account information, he or she may login to the incident reports system 10 of the present invention.

There are two authentication methods that may be employed during the login in step 100. User authentication may be either by user name and password or a 2-factor authentication. In the former, a user providing a correct combination of login name and password may access the incident report system 10. In the latter, advanced security technology (such as ACE Server/SecurID token technology marketed by RSA Security Inc. of Bedford, Mass.) may be integrated with the Incident Report system 10 for use during the login step 100. With Two-Factor Authentication, the user's password becomes their PIN plus a hidden string of characters. For instance, each user may receive a personal SecurID token having a hidden 6-digit numerical string. The user further selects a 4-digit personal identification number (PIN) that is appended to the hidden numerical string in the SecurID token. The user's password is therefore the combination of the 4-digit PIN plus the hidden 6-digit SecurID numerical string. The 6-digit numerical string in the SecurID token automatically changes every 60 seconds, so it is difficult for an unauthorized user to access the Incident Report System, even with an authorized user's login identifier and password.

Optionally, after an initial successful login, the user may be required to change an initial password to a unique password before accessing other options in the application. Changing the password after initial login is a security precaution. The application tracks the user's logins so that an initial login has a different result than all subsequent logins. Similarly, the user may be required to change passwords at a defined interval, i.e., 30, 60, 90 days. The interval is defined by the organization's System Administrator and is another security precaution to safeguard user accounts and restrict access to the application.

The User Profile includes a permission level for the user. The different permission levels allow the user to perform varying actions with the incident reporting system 10. For instance, only certain users may edit or remove an incident report after its creation. In one implementation of the present invention, there are four separate permission levels. A user with permission level 1 (basic) access may have the ability to create a new Incident Report and update any existing reports that they have initiated in the last 24 hours. Similarly, a user with permission level 2 (administrative user) access may have the ability to create a new incident report, search for and update any existing incident reports that have been filed by their company and saved in final form, and view all reports that meet the user's Access Profile.

Continuing with the four-tiered permission system, a user with permission level 3 (system administrator) access has full control over the data in the company's system. This level of user may to create a new Incident Report, search for and update any existing Incident Reports that have been filed by their company, create text and graph reports, and manage the data-driven select lists, accounts and options for their company's system. A user with permission level 4 (investigator) access has access to search for and update Incident Reports that meet their Access Profile. The investigator may view all report sections and data. The investigator has an additional section of the report where he may enter any data discovered during the investigation of the incident.

The System Administrator may further include information in the user profile that defines the locations and incident types to which the user may have access. In other words, the System Administrator may define an Access Profile for the user that defines the data that the user may access. Furthermore, the System Administrator may initialize set up the user's Notification Profile to define the locations and incident types for which the user may receive notification. The notification process generally alerts a user of incidents reports of interest (i.e., incidents or location of interest to the user) and is discussed in greater detail below. The Notification Profile may also define the type of notification the user may receive, i.e., e-mail, pager, personal data assistant (PDA), etc.

If the user enters an incorrect user name and/or password, an login error message page is displayed. For instance, if the user has several sequential incorrect login attempts, a login error message page may be displayed informing the user that they need to contact their system administrator for assistance, and that the account may be locked out for a prespecified time period.

In a preferred implementation of the present invention, the user accesses the incident report system 10 via the organization's associated Internet address or Uniform Resource Locator. (URL). Specifically, a user having an Internet connection via various computing devices specifies the appropriate URL to reach the login screen. The incident reporting system 10 in this and other implementations is described in greater detail below.

User Specific Navigation

After the user profile has logged in step 100, the user is presented with the main screen of the Incident Reports system 10, step 200. The application navigation choices for the Incident Reports system 10 reflect the options available in accordance with the user's access level. Specifically, the application navigation choices are generally determined by the user's permission level, as defined in the User Profile during step 100. Several basic options are always present in the navigation regardless of permission level. In modern, menu-based systems, the navigation is generally represented by a tool bar at the top of the page. While the operation of the incident report system 10 of the present invention is described in the context of a windows-based command lists, it should be appreciated that other command interfaces may be employed and their use is foreseen by the present invention. For instance, there is a drop-down select box for Report Options for all users. For administrative and system administrator (level 2 and 3) users, there may be a second drop-down select box for Administrative Options (described in greater detail below). In this way, a user would not be aware of unavailable functions limited to other users.

Creating An Incident Report

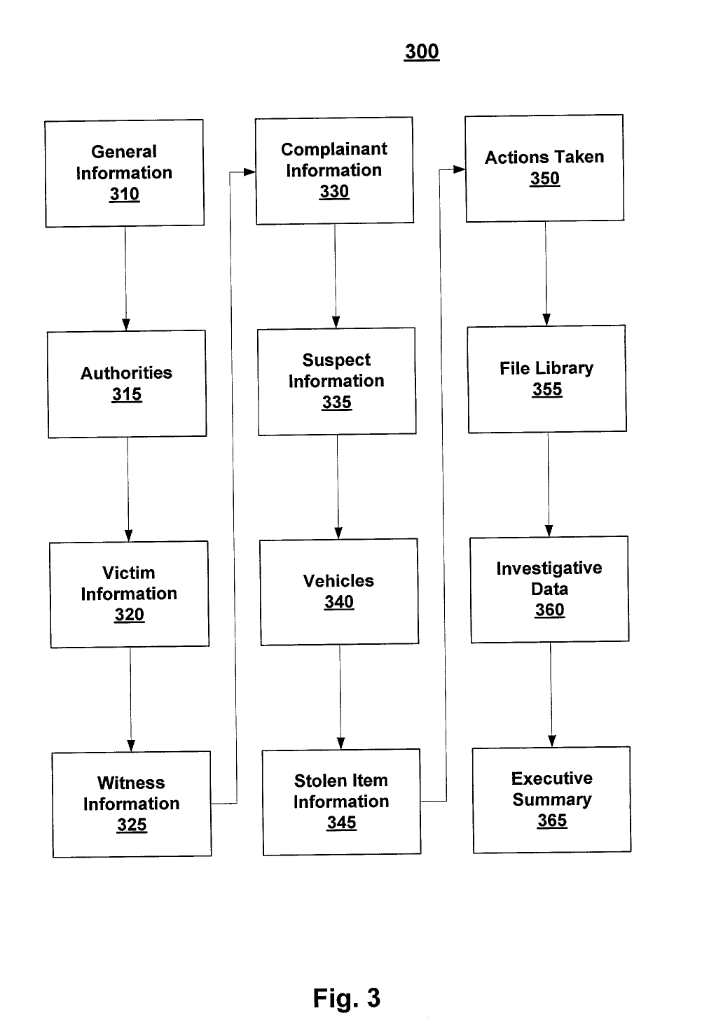

When the user wishes to create an Incident Report (step 300), the user is presented with a wizard-style series of forms for each section of the report. For instance, an incident report may contain, inter alia, General Information, a Narrative, Authorities, Victim Information, Witness Information, Complainant Information, Suspect Information, Stolen Item Information, Vehicles, File Library, Actions Taken, Investigative Data, and Executive Summary. Each of these steps in the creation of the incident report is described in greater detail below, as illustrated in FIG. 3.

General Information

When creating a new Incident Report, the user provides General Information, step 310, to capture the basic information required to create the Incident Report. General Information may generally include:

Case Number used to identify the specific Incident Report. A Case Number is typically generated automatically based on location, current date and a unique identifier from the database.

Location used to identify the location of the incident of concern. The user may select a Location may from a data-driven drop-down select list containing locations stored in database.

Incident Status (e.g., open or closed) typically selected from a data-driven drop-down select list containing status options stored in database. For new reports, this data field is generally defaulted to Open to signify that the problem is new and, as yet, unresolved.

Reporting Official generally selected from a data-driven, drop-down select list containing names of potential reporting officials stored in the database. The default value for this data field is the name of the logged-in user, if applicable.

Date Occurred represents the date that the incident occurred. The Date Occurred is generally a free form text entry field, i.e., mm/dd/yyyy representing the month, data and year. The Date Occurred data value may be defaulted to the date of entry for the Incident Report.

Incident Type identifies the class or category in which to place the particular incident. The user may specify this data field through a categorized list of checkboxes driven by available incident types stored in the database. The user may select multiple Incident Types for a particular incident. Further types of data that may be included in the general information for an incident include a Point of Contact, a Jurisdiction, and Modus Operandi. These entries are typically free form text entry fields.

Once the General Information is defined, an e-mail, pager and/or PDA message may be automatically sent to all users potentially interested in the incident (i.e., with the incident location and incident type defined in their Notification Profile) notifying them that a new Incident Report has been entered. The notification process is described in greater detail below.

The user may further supply a Narrative for the incident during step 310. The user may provide the Narrative data field through a free form text entry area. In connection with the Narrative data field, a toolbar or other type of software control interface may allow the users to employ word-processing style tools to format and spell check the text in the Narrative.

If the user fails to enter any required information for an Incident Report, a JavaScript alert is displayed prompting the user to enter the required information. No action is taken until all of the required information is entered. Similarly, if the user enters data in an incorrect format in a validated form field, a JavaScript alert is displayed prompting the user to enter the data in the correct format. Again, no action is taken until the data is entered in the correct format.

Authorities Information

When applicable, the user may next supply data related to Authorities involved with the incident, step 315. For instance, the user may select from a list of the possible Authorities. Typically, an Incident Report may have multiple authorities entered. For example, the user may supply some or all of the following information when creating an Incident Report:

Was a Police Report Filed?

If yes,

what is the Police Report Number;

what is Police Case Number;

what is Date of Police Report;

what is reporting Officer Name; and

what is reporting Officer Badge Number?

Was a Fire Report Filed?

If yes,

what is the Fire Report Number;

what is the Fire Case Number; and

what is the date of Fire Report.

Victim Information

Once the user has provided the Authorities information, the incident report system may prompt the user to specify Victim Information. When applicable, the user may specify one or more victims from an incident, step 320. The first and last name of the victims assigned to an incident report may be displayed in the left-hand column. The user may click on a victim's name to populate the data in the form fields. There are two ways to assign a victim to an incident report. The user may enter the victim information using free form text entry data fields for a last name, a first name, a home phone, a work phone and/or a victim account. Alternatively, the user may select the victim from the database of previously specified victims. If the victim is selected from the database, the last name, first name, home phone and work phone may be populated by the values stored in the database. Specifically, when a user opts to add a new victim, a pop up layer allows the user to search the database for a desired name.

Witness Information

When applicable, the user may specify Witness Information for the Incident Report, step 325. An incident report may have multiple witnesses. The incident report may display the first and last name of assigned witnesses. As with victims, there are two ways to assign a witness to an incident report: (1) the user may type in the witness information (with free form text entry fields for a last name, a first name, a home phone, a work phone and a witness statement) or (2) the user may select the victim from the database. If the witness is selected from the database, the last name, first name, home phone and work phone may be populated by the values stored in the database.

Complainant Information

When applicable, the user may specify one or more complainants for the incident report, step 330. The first and last names of the complainants assigned to an incident report are displayed. The user may click on a complainant's name to populate the data in the form fields. Again, there are two ways to assign a complainant to an incident report. The user may type in free form text entry fields for the complainant information (such as a last name, a first name, a home phone, a work phone and the complaint) or the user may select the complainant from the a list of previously entered complainants stored in a database. If the complainant is selected from the database, the last name, first name, home phone and work phone may be populated by the values stored in the database.

Suspect Information

The user may further provide another set of data for the Incident Report to specify Suspect Information related to one or more suspects to an incident, step 335. The first and last name of the suspects assigned to an incident report may be displayed after entered by the user. The user may then click on a suspect's name to populate the data in the form fields. As before, the user may type in the Suspect Information using various free form text entry fields for data such as a last name, a first name, a home phone, a work phone, eye color, hair color, weight, height, race, gender, age, clothing, distinctive features, etc. or the user may select the suspect from the database of previously entered suspects. If the suspect is selected from the database, the last name, first name, home phone and work phone may be populated by the values stored in the database.

Once a suspect has been added, the user may further upload a photo of the suspect during step 335. Typically, the user may browse a database or add an image file to upload and associate with this suspect. Users may delete photos that have already been uploaded, or they may click on an uploaded photo to view.

Vehicles

As needed to describe an incident, the user may include a description of one or more vehicles in the incident report, step 340. The user may type in the Vehicle Information using various free form text entry fields for data needed to describe a vehicle such as the vehicle's Make, Model, Color, Body Style, and general Vehicle Description. In a preferred implementation, the make and model of the vehicles are assigned to, and displayed with, an incident report. The user may then click on a vehicle make and model to populate the data in the form fields.

Stolen Item Information

When needed, the user may provide Stolen Item Information to describe one or more stolen items in connection with an incident report, step 345. The category and name of the item of the stolen item assigned to an incident report may be displayed. The user may click on an item to populate the data in the form fields. The user may provide other data associated with a stolen item including:

the Stolen Item Category;

the particular Stolen Item;

a Serial Number;

a Model Number;

a Quantity;

an Item Value;

a Replacement Cost;

a Recovery Value;

an Asset Tag Number; and

a Description: free form text entry area.

During step 345, the user may import (i.e., upload) a comma separated (CSV) file containing a list of stolen item information. A CSV database file is a simple, flat-text database where entries into different fields are separated using commas. The first line of the file is usually reserved for field names and each following line contains one separate record. A CSV database file may be created using various Desktop Applications, including most database and spreadsheet applications. The user may simply design a database using an application, then ask to save/export the database to CSV format. Alternatively, a CSV creation application, such as a Perl/CGI script, may be designed to add records to CSV database files. The user may also employ a standard text editor to create the CSV file. The acceptance of a CSV file into an incident report is convenient to import the contents of a bill of lading or order form without requiring the user to do a significant amount of data entry. Each line item in the CSV file is treated as a stolen item exactly as if the item were entered in the Stolen Item Information form manually.

File Library

In a preferred implementation of the present invention, the user may upload any supporting documentation and associate this documentation with an Incident Report, step 350. For instance, a user may import various text and image files associates with an incident. Typically, the user may specify a Title of a desired file, an Author of the file, and a Description of the desired file. By including meaningful information in the Title and Description, the Title and Description may be searched to, located, and used. For instance, a user may insert various witness statements and images from an incident.

Action Taken

For a user having a correct permission level, the user may specify information related to describe any action or preventive measures taken to prevent the incident from recurring, step 355. For example, an incident report may include a description of an action, the date of the action, and the name of the person taking the action. This section of the Incident Report is available to level 2 and 3 users only. Level 1 users generally cannot see this option in the report navigation.

Investigative Data

The user may also specify investigative data in an incident report, step 360. Specifically, the user may detail the efforts to investigate an incident, including the date of the investigation and the name of the person investigating, along with any other investigative data, such as the results of the investigation. The investigative data is generally editable by users with permission level 2, 3 or 4, but is primarily used by permission level 4 users (the investigators).

Executive Summary

The next step in the creation of an incident report is to form one or more executive summaries of the incident, step 365. The executive summary, the date of the executive summary and the name of the person entering the executive summary may be displayed in the incident report. The Executive Summary created in step 365 is generally available to level 2 and 3 users only. Level 1 and 4 users may not see this option in the report navigation.

Search for Incident Report

Returning now to FIG. 2, following the creation of one or more incident reports in step 300, the user may perform several types of searches. The incident report system 10 of the present invention allows users with assigned permissions to search for incident reports and to upload files, step 400. The search interface is an advanced search style interface providing the user with a variety of options to narrow the search results. Search results are generally presented in a hyperlinked list form that users may browse and click on to view and/or edit the Incident Report.

The Search interface generally consists of an advanced search form for users to enter search criteria to narrow the search results. The user may select a search based on any of the incident report defining terms provided in step 300. The Search form may contain, for instance, the following filter options:

Incident Case Number;

Reporting Official;

Date the Incident Occurred;

Incident Status;

Keyword Search Terms;

Incident Location;

Business Unit associated with Incident;

Incident Types; and

Search Uploaded Documents.

Other options may be added to the search form. The user may use any combination of these form fields to create filter information for their search. If the user chooses to search Uploaded Documents, the search results will contain incident reports and uploaded files containing the search terms.

After executing the search according the user's search conditions, the search results will be displayed. For instance, the search may be shown as a list form containing the Case Number, Date Filed, Location of Incident and Date Occurred for incidents matching the search terms. The incident reports that are returned in the search result set will be only those reports that the user has the ability to view (the ability defined in the Account Profile by permission level and in the Access Profile by Location and Incident Type). Depending on the user's permission level, an incident report is presented in editable or uneditable form. Each case number in the result set may be hyperlinked to the actual report, enabling the user to click on the hyperlink to access the report directly from the search result screen. If uploaded files are included in the result set, the name of the uploaded file will be hyperlinked to the file.

If the user neglects to enter required information in a form or enters data in an incorrect format in a validated form field, a JavaScript alert is displayed prompting the user to re enter the requested data. No action is taken until the data is entered in the correct format.

List Incident Reports

In step 500, users with proper permission level (such as level 2, 3 or 4 permission level in the four tier permission scheme described above) may choose to list the incident reports submitted by their organization. Depending on the user's Access Profile that defines the Locations and Incident Types available to the user, appropriate incident reports are displayed in a list format, similar to the above-described Search result list. For instance, the list for an organization may display the Case Number, Date Filed, Location of Incident, and Date Occurred data for the incident reports filed by an organization. The listing may be hyperlinked to allow the user to easily access and view a report of interest. The default order of the report display may be organized by the date occurred, with the most recent reports showing at the top of the list. By selecting a hyperlink to an incident report, the user may access report sections associated with the incident, thereby allowing the user to view, edit, or delete the report.

Create Text Reports

The Incident Report system 10 further allows users with permission level 2 and 3 to create text reports, step 600. Users will have the option to enter specific criteria to build their reports, and the reports may be displayed on screen in printable format, such as HTML. Possible text reports include (1) Incidents by Location/Type Summary, (2) Incident Reports by Incident Type, (3) Incidents, (4) Thefts, and (5) Incidents by Location. Each of these report options has its own customized criteria entry interface that allows users to build a custom report. The report-building interface in the incident report system 10 further allows the user to build a customized report. For example, a user may chose to enter a start and end date range to include in the report, select a location or list of locations to include in the report, select incident report status to include in the report and select incident types to include in the report. The user may enter any combination of criteria inputted in step 300. In this way, the user may group together different incident reports that satisfy particular conditions or characteristics. The text report generally allows the user to select a particular Location to view report details for only that location, an Incident Type to view report details for that incident type or a Case Number to view that particular incident report.

Create Graphical Reports

Similarly, users with permission level 2 and 3 may create graphical reports, step 700. The incident reports system 10 offers dynamic graphical reports to the user. The user enters the report criteria they wish to display in the graph, and the incident reports system 10 dynamically generates the graph per the users specification. The user may then print the graphical reports.

The same report-building interface used for building text reports is used for specifying criteria for a graphical report. The basic IncidentReports.com application offers several standard graphical reports; including several bar charts and a pie chart. The graphical charts may include (1) Incidents Pie Chart, (2) Incident Reports by Type, (3) Incident Reports by Location, and (4) Thefts (bar chart). All data represented in the graphical reports is user specified in the custom report-building interface.

The report-building interface allows the user to enter, for instance, a start and end date range to include in the report, select a location or list of locations to include in the report, select incident report status to include in the report and select incident types to include in the report. The user may enter any combination of criteria.

The graphical report may be presented as a standard graphics file, such as JPEG images. With the graphics file, the use may view, print, or electronically transfer the graphical report.

In a preferred implementation, the graphical reports are presented by default as ActiveX controls. The ActiveX control gives the user a rich interface for manipulating the chart. By right-clicking on the chart, the user may show/hide the toolbar, hide/display the legend, change the type of chart, change the chart colors, change the chart title, change the font or view the properties of the chart. The chart toolbar will allow the user to save the chart as a standard image file (such as a GIF or a JPEG). Graphical reports presented as ActiveX controls also allow the user to specify elements on the chart to view the corresponding text detail report.

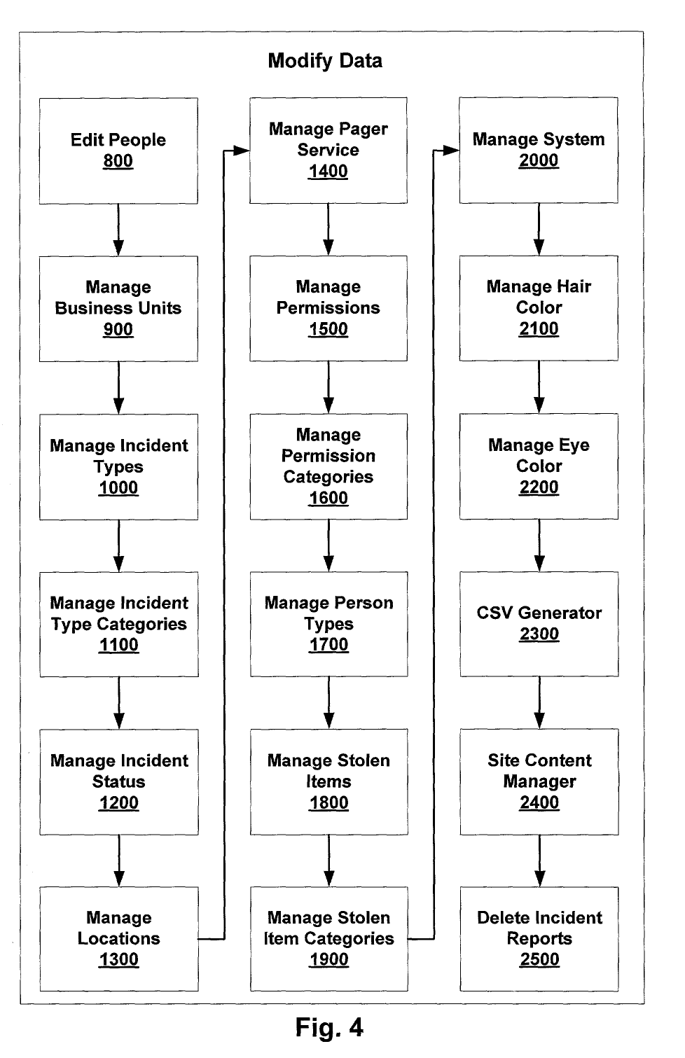

Turning now to FIG. 4, the user may manage the data used the creation and use of the incident report, steps 800-2500.

Edit People

Particular users may edit the profiles for other users, step 800. Each organization using incident reports should have at least one designated user with permission level 3, system administrator access (or similar permission level access). The system administrator is responsible for maintaining the systems data-driven options, users and account permissions and administering the Incident Reports filed by their company.

A system administrator may add new accounts, edit existing accounts and delete accounts. The system administrator manages personal information, notification profile (paging, e-mail, wireless), account information, and Incident Report access privileges.

To enter a new person into the database, the system administrator enters the new person's personal information, such as a first name, last name, company, e-mail address, business telephone, home telephone, person type, whether the person is a security officer, and point of contact.

To edit an existing user, the system administrator first specifies the user(s) to be edited. For instance, the system administrator may search for a user meeting certain characteristics or criteria. Users in the database matching the search criteria will be listed in alphabetical order in the search pop-up layer. The system administrator may then select a user to edit, and the user's information is automatically populated. At this point, the system administrator may edit any of the user's personal information, Notification Profile, Account Profile and Access Profile.

To delete an existing person, the system administrator again specifies the user(s). Typically, the system administrator enters the full or partial first and/or last name of the user. Alternatively, the system administrator may search using other user information, such as (1) the company for which the user being sought works; (2) the desired user's EMail address; (3) the desired user's Work Phone; (4) the desired user's Home Phone; (5) Person Type; (6) Contact for the desired user; (7) Employee Status; (8) whether the user is a Security Officer. All users in the database matching the search criteria will be listed in alphabetical order, and the system administrator may select a user to be deleted. Alternatively, the system administrator may view all users in the database and select a user to be deleted.

As described above, the system administrator stores, in the user's account profile, the user's permission level, the user's password, the locations where the user works, and the application options (within the selected permission level) to which the user has access. The system administrator may edit any or all of these settings. When the system administrator modifies a user's permission level, the application options available to that permission level are displayed as a series of checkboxes. This allows the system administrator to further define and abstract what a specific user may do in the application. There may also be a text field for the system administrator to assign a password. Locations are displayed as a series of checkboxes to allow the system administrator to denote in which locations the user primarily works.

The user's notification profile controls whether the user receives any electronic notification of new incident reports. Notification methods are typically by e-mail, pager and/or PDA. Notifications are distributed by location and incident type. System administrators may abstract user's Notification Profile by location and incident type.

The Access Profile allows the system administrator to control the user's access to incident reports by locations and incident types. For example, the system administrator may limit a user's access to only those incident reports at Location 1 and having an incident type of theft. The user would then not be able to see any incident report that wasn't entered for Location 1 and of incident type theft. The Access Profile is independent of the permission level and provides a way to further restrict an individual user's access privileges.

Manage Business Units

Part of the System Administrator's responsibility is to maintain the information that populates that data-driven select lists and dynamic checkboxes used throughout the incident reports system 10, step 900. The system administrator may add, edit or delete business units from the Business Unit database table. The values in the Business Unit database table populate the data-driven select lists in the incident reports system 10. Even if a business unit is deleted, any report that is using the business unit will still remain intact and display the business unit.

Manage Incident Types

Another of the System Administrator's responsibilities is to maintain the information that populates that data-driven select lists and dynamic checkboxes used throughout the incident reports system 10, step 1000. The process of Manage Incident Types in step 1000 generally entails adding, editing or deleting incident types from a Incident Types database table. The values in the Incident Types database table populate the data-driven select lists in the application. The System Administrator may add a new incident type or select an existing incident type to edit or delete. When an incident type is added or edited, the modification is displayed in the application select lists instantaneously. When an incident type is deleted, a database flag is set that will drop the incident type from the select list values. Any report that is using the incident type, however, will remain intact and display the incident type.

Manage Incident Type Categories

Another task for the System Administrator is to add, edit or delete incident type categories from the database, step 1100. The values in the Incident Type Category database table populate the data-driven select lists in the application. The System Administrator may add a new incident type category or select an existing incident type category to edit or delete. When an incident type category is added or edited, the modification is displayed instantaneously. When an incident type category is deleted, the category is first checked for related incident types. If there are related incident types, an alert message will be displayed telling the user that related incident types may be deleted prior to deleting a category. If no related incident types are found, a database flag is set that will remove the incident type category from the select list values.

Manage Incident Status

Another task for the System Administrator is to maintain the information defining incident status. The values in the Incident Status database table populate the data-driven select lists generally employed in step 300 to create or edit an incident report. For example, an incident may be closed or may be under investigation by either internal investigators or public authorities. The system administrator may add a new incident status or select an existing incident status to edit or delete. When an incident status is added or edited, the modification is displayed. When an incident status is deleted, a database flag is then set, which removes the incident status from the select list values. Any report that is using the deleted incident status, however, will generally remain intact and display the deleted incident status.

Manage Locations

In performing maintenance on the incident report system 10, a system administrator may add, edit or delete locations for the organization that are stored in the database, step 1300. The System Administrator may add a new location or select an existing location to edit or delete. When a location is added or edited, the modification is displayed in the application select lists. When a location is deleted, a database flag is set, which removes the location from the select list values. Any incident report that is using the location, however, will remain intact and display the location.

Manage Pager Service

The adding, editing or deleting pager services in step 1400 modifies the Pager Service stored in a database. The values in the Pager Service database table help to populate the data-driven select lists, generally employed in step 300. The System Administrator may add a new pager service or select an existing pager service to edit or delete. When a pager service is added or edited, the modification is displayed in the application select lists instantaneously. When a pager service is deleted, a database flag is set which will drop the pager service from the select list values. Any report that is using the pager service, however, will still remain intact and display the pager service.

Manage Permissions

The managing of permissions is step 1500 entails adding, editing or deleting Permissions from a database table. Permissions refer to the options found on the operations menu, described above. The System Administrator may add a new Permission or select an existing Permission to edit or delete. When a Permission is added or edited, the modification is displayed in the menu instantaneously. When a Permission is deleted, a database flag is set which will drop the Permission from the select list and may longer be selected by users.

Manage Permission Categories

The option to manage permission in step 1600 allows a System Administrator to add a new permission category or to select an existing permission category to edit or delete. When a permission category is added or edited, the modification is displayed in the application select lists. Conversely, when a permission category is deleted, any permission that is currently assigned to the permission category will be affected. The System Administrator will be prompted to reassign the permissions before deleting the permission category. When a permission category is deleted a database flag is set which will drop the permission category from the select list values.

Manage Person Type

The managing of Person types in step 1700 involves adding, editing or deleting person types from a person types database table. The values in the Person types database table are used to populate the data-driven select lists used in step 300 and other aspects of the present invention. The System Administrator may add a new person type or select an existing person type to edit or delete. When a person type is added or edited, the modification is displayed in the select lists. When a person type is deleted, a database flag is set, which removes the person type from the select list values. Any report that is using the person type, however, will remain intact and continues to display the person type.

Manage Stolen Items

During the managing of Stolen Items in step 1800, a user may add, edit or delete stolen items from a Stolen Items database table. The values in the Stolen Items database table populate the data-driven select lists in the application. When a stolen item is added or edited, the modification is instantaneously displayed in the application select lists. When a stolen item is deleted, a database flag is set, which removes the stolen item from the select list values. Any report that is using the stolen item, however, will remain intact and display the stolen item.

Manage Stolen Items Categories

The managing of the Stolen Item Categories in step 1900 relates to adding, editing or deleting Stolen Item Categories from the Stolen Item Categories database table. The values in the Stolen Item Categories database table populate the data-driven select lists. The System Administrator may add a new Stolen Item Categories or select an existing Stolen Item Categories to edit or delete. When a Stolen Item Categories is added or edited, the modification is displayed in the application select lists. When a stolen item category is deleted, any stolen item that is currently assigned to the stolen item category will be affected. The System Administrator will be prompted to reassign the stolen items before deleting the stolen item category. Any report that is using the stolen item in the category, however, will remain intact and display the stolen item.

Manage System

The managing of the System in step 2000 relates to changing the system configuration for the System Administrator's site. For instance, a System Administrator may specify the base time zone for the system or a company proxy server that will be used to filter traffic from inside the company.

Manage Hair Color

The managing of options for Hair Color in step 2100 is used for adding, editing or deleting Hair Colors from the Hair Color database table. The values in the Hair Color database table may be used populate the data-driven select lists. The System Administrator may add a new Hair Colors or select an existing Hair Colors to edit or delete. When a Hair Color is added or edited, the modification is displayed in the application select lists. Any report that is using the hair color, however, will remain intact and display the hair color

Manage Hair Color

The System Administrator may likewise manage eye color choices in step 2200 by adding, editing or deleting eye colors from the eye color database table. The values in the eye color database table populate the data-driven select lists. When an eye color is added or edited, the modification is displayed in the application select lists. Again, any incident report that is using a deleted eye color, however, will remain intact and continue to display the eye color

CSV Generator

An added feature that is available to System Administrators is to generate a CSV, step 2300. This step allows the System Administrator to query and retrieve data from the IncidentReports.com database in an easy-to-use, web-based interface. The System Administrator specifies the data to be retrieved and selects a button to generate a .csv file (described above). This feature enables System Administrators to share their incident data with other productivity and intelligence gathering tools such as an intelligence database. Once a .csv file is generated, the System Administrator may then import the file into any spreadsheet or database capable of accepting .csv data.

The generation of a CSV in step 2300 is a two-step process. First, the System Administrator selects the database table from which to retrieve data and enters a date range. The date range is useful to generate CSV files on a quarterly or monthly basis and provides a mechanism to prevent the data from overlapping with each CSV Generation. Tables that may be selected by a user include Victims, Witnesses, Complainants, Suspects and Vehicles. Next, the System Administrator selects the database fields to include in the CSV file. Fields that are available for selection are dynamically generated based on the table selection in the previous step. The user may save or open the file in the spreadsheet program associated with .csv files, such as Microsoft Excel®.

Site Content Manager

In step 2400, the user may manage the content that is displayed on the client home page after a user accesses the application. For instance, the system administrator may post pertinent company announcements, procedures and information for all users. Accordingly, the system administrator may add, edit or delete headings and add, edit or delete content associated with a heading.

Delete Incident Reports

In step 2500, a system administrator may delete unwanted incident reports. If an incident report is deleted, all data associated with the incident report (e.g., General Information, Authorities, Narrative, Victims, Witnesses, Complainants, Suspects, Vehicles, Stolen Items, File Library, Actions Taken, Investigative Data, and Executive Summary) will be deleted from the database. To delete an incident report, the user typically enters a case number in the text field. In one embodiment, the user may, prior to deleting it, may view the incident report's location, incident type, date occurred, and date. A JavaScript confirmation is displayed, asking if the user truly wants to delete the incident report. Upon user confirmation, the report is permanently deleted from the database.

### CONCLUSION

The foregoing description of the preferred embodiments of the invention has been presented for the purposes of illustration and description. It is not intended to be exhaustive or to limit the invention to the precise form disclosed. Many modifications and variations are possible in light of the above teaching. For instance, the method of the present invention may be modified as needed to incorporate new communication networks and protocols as they are developed. It is intended that the scope of the invention be limited not by this detailed description, but rather by the claims appended hereto. The above specification, examples and data provide a complete description of the manufacture and use of the composition of the invention. Since many embodiments of the invention may be made without departing from the spirit and scope of the invention, the invention resides in the claims hereinafter appended.

What is claimed:

1. A method for recording and using incident report data comprising:
a step for creating one or more incident reports;
storing the incident reports in a database; and
searching the incident reports.

2. The method of claim 1 further comprising the step of listing the incident reports.

3. The method of claim 1 further comprising a step for creating a description of the incident reports.

4. The method of claim 3 wherein said description creation step comprises creating a text report.

5. The method of claim 3 wherein said description creation step comprises creating a graphical report.

6. The method of claim 1 further comprising the steps of:
logging in a user; and
providing the user a program menu in dependence of the login.

7. The method of claim 6, wherein the step of logging in the user defines the user's access to the database.

8. The method of claim 6, wherein the step of logging in the user defines the user's ability to create; modify, and delete data.

9. The method of claim 6 further comprising a step for modifying data.

10. A system for recording and using incident report data comprising:
a server;
an application on the server for recording and using said incident report data;
a database connected to said server for storing said incident report data;
a computing device; and
a network connecting the server and the computing device.

11. The system of claim 10, wherein said computing device is a Personal Data Assistant (PDA)

12. The system of claim 10 further comprising a wireless connection means through which the computing device may connect to said network.

13. The system of claim 10 wherein said network is the Internet.

14. The system of claim 13, wherein said computing device comprises a browser.

15. The system of claim 10 further comprising a storage device containing one or more files that are not incident reports.

16. A computer program product for recording and using incident report data comprising, the computer program product comprising:
computer readable program code configured to create an incident report;
computer readable program code configured to store the incident report in a database; and
computer readable program code configured to create description of the incident report.

17. The computer program product of claim 16 further comprising a computer readable program code configured to search stored incident report.

18. The computer program product of claim 16 further comprising a computer readable program code configured to list stored incident reports.

19. The computer program product of claim 16 further comprising:
a computer readable program code configured to log in a user; and
a computer readable program code configured to provide the user a program menu in dependence of the log in.

20. The computer program product of claim 19 wherein the computer readable program code configured to log in a user also defines the user's access to the database.

21. The computer program product of claim 19 wherein the computer readable program code configured to log in a user also defines the user's ability to create; modify, and delete data.

22. The computer program product of claim 16 further comprising a computer readable program code configured to modify data.
